(19) United States
(12) Patent Application Publication
(10) Pub. No.: US 2026/0299500 A1
(43) Pub. Date: Oct. 1, 2026

(54) PRINTING SYSTEM, CONTROL METHOD FOR PRINTING SYSTEM, AND STORAGE MEDIUM

(71) Applicant: CANON KABUSHIKI KAISHA, Tokyo (JP)

(72) Inventor: MASASHI YOKOYAMA, Tokyo (JP)

(21) Appl. No.: 19/577,161

(22) Filed: Mar. 24, 2026

(30) Foreign Application Priority Data
Mar. 31, 2025 (JP) 2025-059520

(51) Int. Cl. G03G 15/00; H04N 1/00

(52) U.S. Cl. CPC G03G 15/6573; G03G 15/6514; H04N 1/00037; H04N 1/00076; G03G 2215/00649; H04N 2201/0094

(57) ABSTRACT

A control method for a printing system, that includes a printing apparatus configured to perform printing on a sheet, an inserter apparatus placed on a downstream side of the printing apparatus in a sheet conveyance direction and configured to insert the sheet, and a charge removal apparatus placed on a downstream side of the printing apparatus in the sheet conveyance direction and configured to remove electric charge from the sheet, includes determining whether the inserter apparatus is connected to a downstream side of the charge removal apparatus in the sheet conveyance direction, and notifying a user to connect the inserter apparatus to the downstream side of the charge removal apparatus in the sheet conveyance direction in a case where it is determined that the inserter apparatus is connected to an upstream side of the charge removal apparatus in the sheet conveyance direction.

### BACKGROUND

### Field of the Technology

The present disclosure relates to a printing system having a charge removal function of removing electric charge from a charged sheet, a control method for the printing system, and a storage medium.

### Description of the Related Art

A recording medium (hereinafter referred to as a sheet) used in a printing operation is conveyed in a state in which the sheet is electrostatically charged by residual electric charge in the course of an electrophotographic process or by slight friction that occurs with a conveyance roller or a guide during sheet conveyance. Such static electricity may cause the sheets to adhere to each other.

A sheet such as plain paper has low electric resistance, and electric charge moves within the sheet more easily. The sheet such as plain paper also has a small charge amount, and thus the electric charge of the sheet is eliminated quickly. On the other hand, a sheet such as thick paper and a sheet such as synthetic paper and coated paper using synthetic resin (plastic) have high electric resistance, and electric charge does not tend to move within the sheet. Consequently, the sheets such as synthetic paper and coated paper are charged more easily, and electric charge tends to remain. Moreover, it is generally known that a sheet is influenced by the environment more easily, particularly by humidity, and the sheet is electrostatically charged more easily in a lower humidity environment due to a decrease in an amount of discharge into the air.

In a case in which post-processing is performed in a state in which sheets adhere to each other, processing for aligning the sheets may be affected, and a jam may occur due to a sheet feed failure or a conveyance failure at the time of the post-processing.

Thus, static electricity on the sheet subsequent to the printing is desirably removed before the post-processing is executed. Accordingly, application of voltage to a conveyance roller pair positioned downstream in a sheet conveyance direction has been proposed to eliminate the electric charge on the sheet (See Japanese Patent Application Laid-Open No. H11-258881).

In such a related-art configuration in which voltage is applied to the conveyance roller (hereinafter referred to as a charge removal roller), electric charge opposite to the electric charge on the sheet is imparted to the sheet via the charge removal roller to eliminate the static electricity on the sheet. Thus, an amount of electric charge to be removed by the charge removal roller (application of electric charge opposite to the electric charge on the sheet to the charge removal roller) needs to be set based on a charge amount of the sheet. Conventionally, there are image forming systems having a mode in which a sheet is fed from an apparatus attached to a downstream side of an image forming apparatus in addition to a sheet feed unit for feeding a sheet (a recording sheet) as a recording medium from the image forming apparatus. For example, image forming systems that include an inserter apparatus for feeding a sheet as a slip sheet to output a product with the slip sheet inserted between image-formed sheets are known. In such an image forming system, a conveyance path for a sheet that passes through the image forming apparatus and a conveyance path for a sheet that is fed from the inserter apparatus are different. Moreover, a charged state of a sheet placed on each sheet feed unit differs.

Accordingly, electric charge on the sheet by the conveyance varies depending on whether the sheet passes through the image forming apparatus, and a necessary amount of charge removal differs in both cases. That is, there is a difference in a suitable charge adjustment value for charge removal between cases where the fed sheet passes or does not pass a conveyance path of the image forming apparatus.

Moreover, in a case where a charge removal apparatus for performing charge removal processing on a sheet is configured to be independent of an image forming apparatus and an inserter apparatus, the charge removal apparatus may be arranged on an upstream side of the inserter apparatus. In such arrangement, the charge removal apparatus cannot perform charge removal processing on a sheet fed from the inserter apparatus. Consequently, the sheet fed from the inserter apparatus may cause paper sticking and a sheet jam.

### SUMMARY

According to an aspect of the present disclosure, a printing system includes a printing apparatus configured to perform printing on a sheet, an inserter apparatus placed on a downstream side of the printing apparatus in a sheet conveyance direction and configured to insert the sheet, a charge removal apparatus placed on a downstream side of the printing apparatus in the sheet conveyance direction and configured to remove electric charge from the sheet, and at least one processor configured to generate a notification that notifies a user to connect the inserter apparatus to a downstream side of the charge removal apparatus in the sheet conveyance direction in a case where it is determined that the inserter apparatus is connected to an upstream side of the charge removal apparatus in the sheet conveyance direction.

Features of various embodiments will become apparent from the following description of embodiments with reference to the attached drawings. The following description of embodiments is described by way of example.

### BRIEF DESCRIPTION OF THE DRAWINGS

FIG. 1 is a diagram illustrating an example of an overall configuration of a system according to the present embodiment.

FIG. 2 is a block diagram illustrating an example of a hardware configuration of a printing system according to the present embodiment.

FIG. 3 is a diagram illustrating an example of a cross section of the printing system according to the present embodiment.

FIG. 4 is a diagram illustrating an example of an operation unit of a printing apparatus included in the printing system according to the present embodiment.

FIG. 5 is a diagram illustrating an example of an operation unit of a charge removal apparatus included in the printing system according to the present embodiment.

FIG. 6 is a diagram schematically illustrating a state in which the charge removal apparatus performs charge removal processing according to the present embodiment.

FIG. 7 is a diagram illustrating an example of a cross section of the printing system according to the present embodiment.

FIG. 8 is a flowchart illustrating processing according to a first embodiment.

FIG. 9 is a diagram illustrating an example of a screen of the printing system according to the first embodiment.

FIG. 10 is a flowchart illustrating processing according to a second embodiment.

### DESCRIPTION OF THE EMBODIMENTS

Hereinafter, example embodiments of the present disclosure are described with reference to the drawings.

It is to be understood that the following embodiments are not intended to limit the scope of the claims, and that not all of the combinations of the aspects described in the following embodiments are necessarily required with respect to any issue to be solved by the present disclosure.

### FIRST EMBODIMENT

### Overall Configuration of System

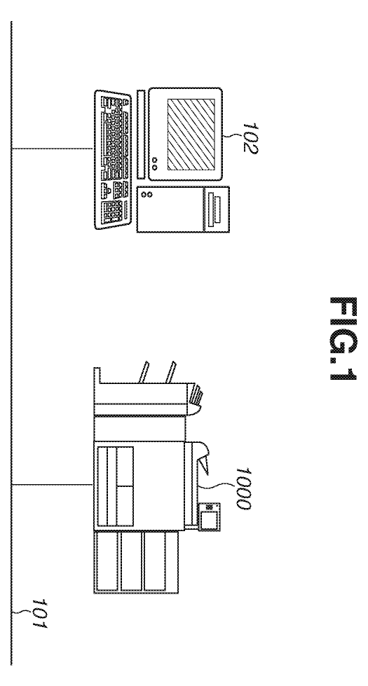

FIG. 1 is a diagram illustrating an example of an overall configuration of a system according to one embodiment of the present disclosure.

The system of the present embodiment includes a printing system 1000 and a personal computer (PC) 102 that is a client computer. The printing system 1000 and the PC 102 are mutually connected via a network 101.

The PC 102 can transmit code data (page description language) that is a print job to the printing system 1000 via the network 101.

### Hardware Configuration of Printing System

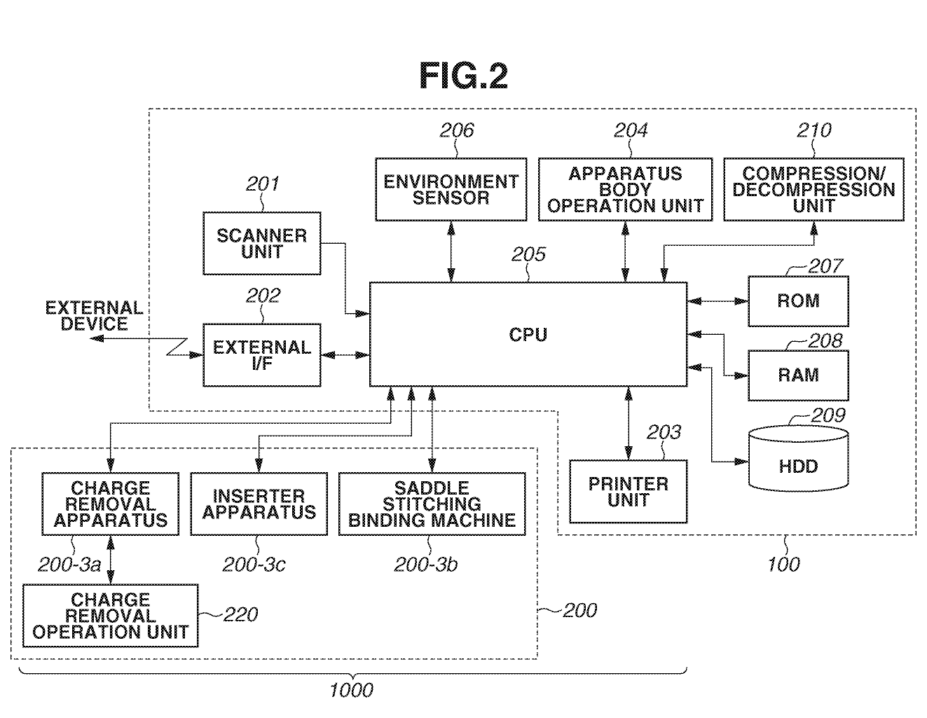

FIG. 2 is a block diagram illustrating an example of a hardware configuration of the printing system 1000.

The printing system 1000 includes a printing apparatus 100 and a sheet processing apparatus 200 each of which is indicated by a dotted line in FIG. 2. Any number of the sheet processing apparatuses 200 can be connected to the printing apparatus 100. The sheet processing apparatus 200 of the present embodiment is described using an example case in which the sheet processing apparatus 200 is formed of a charge removal apparatus 200-3a, a saddle stitching binding machine 200-3b, and an inserter apparatus 200-3c. In the present embodiment, moreover, a multifunction peripheral (MFP) having a plurality of functions such as a copy function and a printer function is described as an example of the printing apparatus 100. However, the printing apparatus 100 can be a single-function type printing apparatus having only a copy function or a printer function. In the present embodiment, the printing system 1000 including various components below is described as one example.

The printing system 1000 is configured such that the sheet processing apparatus 200 connected to the printing apparatus 100 executes sheet processing on a sheet printed by the printing apparatus 100. However, the printing system 1000 may be configured to include only the printing apparatus 100 without connection of the sheet processing apparatus 200. The inserter apparatus 200-3c can communicate with the printing apparatus 100 and the charge removal apparatus 200-3a described below, and can execute insert processing described below upon receipt of an instruction from the printing apparatus 100.

The charge removal apparatus 200-3a can communicate with the printing apparatus 100, and can execute charge removal processing described below upon receipt of an instruction from the printing apparatus 100.

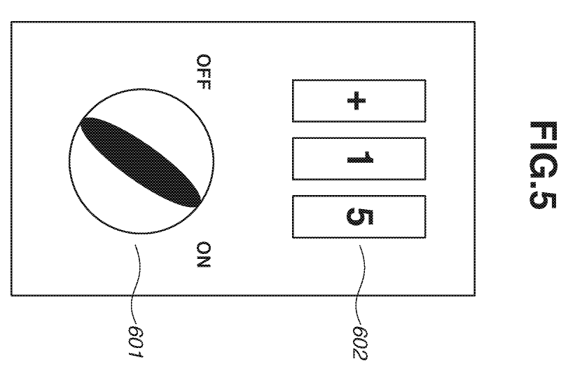

A charge removal operation unit 220 has a configuration as illustrated in FIG. 5, and a user can make a setting for the charge removal apparatus 200-3a via the charge removal operation unit 220.

The user may make a setting for the charge removal apparatus 200-3a via an apparatus body operation unit 204 described below.

The saddle stitching binding machine 200-3b can communicate with the printing apparatus 100, and can execute sheet processing described below upon receipt of an instruction from the printing apparatus 100.

### Printing Apparatus

A scanner unit 201 reads an image on a document, converts the read image into image data, and then transfers the image data to another unit.

An external interface (I/F) 202 transmits and receives data to and from an external device connected to the network 101.

A printer unit 203 prints an image on a sheet based on the image data which has been input.

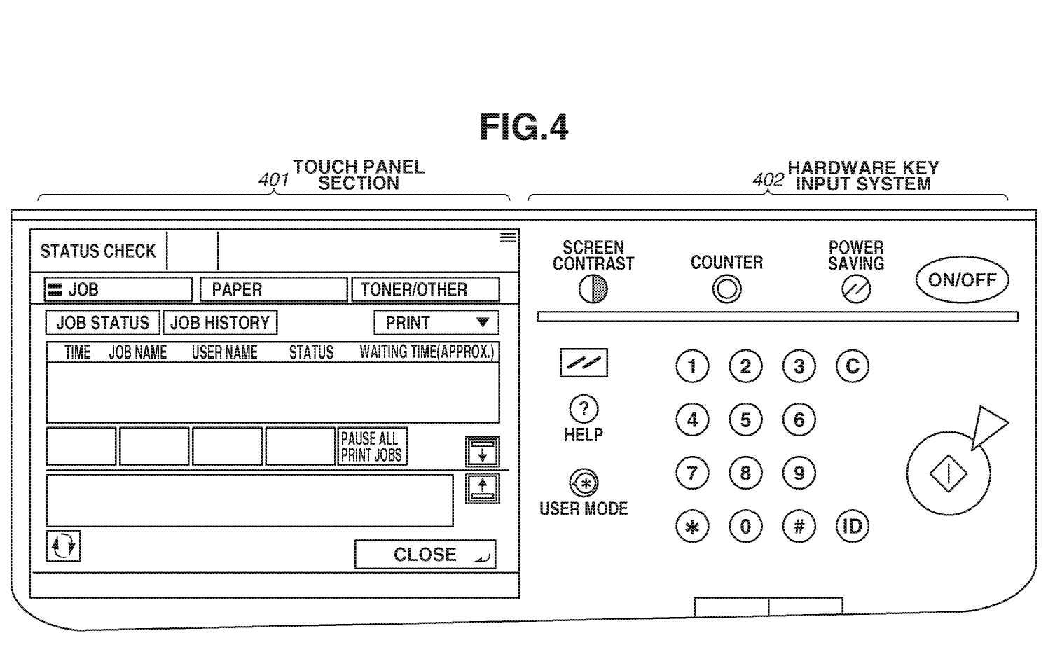

The apparatus body operation unit 204, as illustrated in FIG. 4, includes a touch panel section 401 and a hardware key input section 402. The apparatus body operation unit 204 receives an instruction from a user via the touch panel section 401 and the hardware key input section 402. The apparatus body operation unit 204 displays various pieces of information on the touch panel section 401.

A central processing unit (CPU) 205 comprehensively controls the printing system 1000, for example, operations and processing of various units of the printing system 1000. That is, the CPU 205 also controls operations of the printing apparatus 100 and the sheet processing apparatus 200 connected to the printing apparatus 100.

An environment sensor 206 is a generic term of a sensor that detects setting environment such as temperature and humidity. In the present embodiment, a temperature sensor and a humidity sensor correspond to the environment sensor 206. An example of the temperature sensor generally includes a thermistor that measures air temperature. An example of the humidity sensor generally includes a detector that detects air humidity based on a change in capacitance. An output of each of the temperature sensor and the humidity sensor is output as an electric signal. The CPU 205 continuously monitors temperature and humidity of the environment in which the printing apparatus 100 is placed, and the resultant data is reflected in the control of the printing apparatus 100.

A read only memory (ROM) 207 stores various computer programs that are executed by the CPU 205.

For example, the ROM 207 stores a program for causing the CPU 205 to execute various kinds of processing in the flowchart described below, and a display control program necessary for displaying various setting screens described below. Moreover, the ROM 207 stores a program for causing the CPU 205 to interpret page description language (PDL) code data received from the PC 102 and to execute an operation for converting the data into raster image data.

In addition, the ROM 207 stores, for example, a boot sequence and font information.

A random access memory (RAM) 208 stores PDL code data and image data transmitted from the scanner unit 201 or the external I/F 202, various programs loaded from the ROM 207, and setting information. The RAM 208 also stores information about the sheet processing apparatus 200 (e.g., information about a type and functions of the sheet processing apparatus 200 connected to the printing apparatus 100). The CPU 205 can use information about the sheet processing apparatus 200 stored in the RAM 208 to perform a control operation.

A hard disk drive (HDD) 209 includes, for example, a hard disk and a driving unit by which data is read from and written in the hard disk. The HDD 209 is a large-capacity storage device to store image data that is input from the scanner unit 201 and then compressed by a compression/decompression unit 210. The CPU 205 can cause the image data stored in the HDD 209 to be printed by the printer unit 203 based on an instruction from a user. The HDD 209 is also used as a spooler, and the CPU 205 can manage the PDL code data received from the PC 102 as a print job and store the print job in the HDD 209. In addition, the CPU 205 can manage the print job stored in the HDD 209, and can acquire the number of stored print jobs and setting information for the print job. Other storage devices such as a solid state drive (SSD) and an embedded multi-media card (eMMC) may be included instead of or in combination with the HDD.

The compression/decompression unit 210 compresses and decompresses data such as image data stored in the RAM 208 and the HDD 209 by using various compression methods, for example, Joint Bi-level Image Experts Group (JBIG) and Joint Photographic Experts Group (JPEG).

The printing system 1000 of the present embodiment is a printing system including a charge removal apparatus the charge removal function setting of which is changeable. The printing system 1000 will be described in detail below.

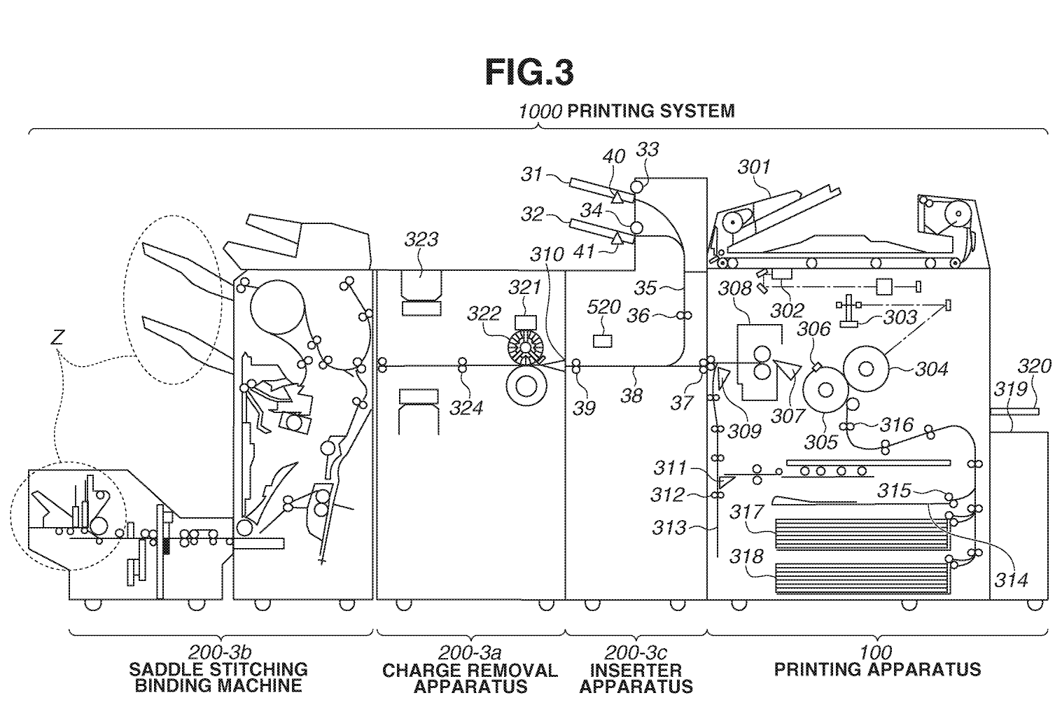

FIG. 3 is a diagram illustrating an example of a cross section of the printing apparatus 100 and the sheet processing apparatus 200 connected to the printing apparatus 100 according to the first embodiment.

The sheet processing apparatus 200 of the present embodiment includes the charge removal apparatus 200-3a, the saddle stitching binding machine 200-3b, and the inserter apparatus 200-3c.

### Printing Apparatus

First, the printing apparatus 100 is described.

An automatic document feeder (ADF) 301 separates a bundle of documents that are set on a stacking side of a document tray from a first-page document in page order, and conveys the separated document to a platen glass so that the separated document is scanned by a scanner 302.

The scanner 302 reads an image of the document conveyed to the platen glass, and converts the read image into image data by using a charge coupled device (CCD).

A rotary polygon mirror (e.g., a polygon mirror) 303 causes, for example, a light beam such as a laser beam modulated based on the image data to enter, and irradiates a photoconductor drum 304 with the beam as reflective scanning light via a reflecting mirror.

A latent image formed on the photoconductor drum 304 by the laser beam is developed with toner, and then is transferred to a sheet material attached to a transfer drum 305. A series of such image forming processes are sequentially executed with respect to yellow (Y), magenta (M), cyan (C), and black (K) toners, so that a full color image is formed. After the image forming process is performed four times, a separation pawl 306 separates the sheet material on which the full color image is formed from the transfer drum 305, and the separated sheet material is conveyed to a fixing unit 308 by a pre-fixing conveyance unit 307.

The fixing unit 308 includes a combination of a roller and a belt, and a heat source such as a halogen heater. The fixing unit 308 melts and fixes the toner of the toner image transferred to the sheet by using heat and pressure.

A sheet ejection flapper 309 is swingable about a swing axis, and defines a sheet conveyance direction. When the sheet ejection flapper 309 is swinging in a clockwise direction in FIG. 3, the sheet material is conveyed straight and ejected to the outside of the apparatus by a sheet ejection roller 310.

The CPU 205 controls the printing apparatus 100 such that single-sided printing is executed by such a series of sequences.

### Duplex Printing

On the other hand, in a case where images are formed on both sides of the sheet material, the sheet ejection flapper 309 swings in a counterclockwise direction in FIG. 3 to redirect the sheet material downward, and the sheet material is fed to a two-side conveyance unit. The two-side conveyance unit includes a reversing flapper 311, a reversing roller 312, a reversing guide 313, and a two-side tray 314.

The reversing flapper 311 swings about a swing axis, and defines a sheet conveyance direction. In a case where a duplex print job is processed, the CPU 205 controls the swinging of the reversing flapper 311 in a counterclockwise direction in FIG. 3 so that the sheet material the first side of which has been printed by the printer unit 203 is fed to the reversing guide 313 via the reversing roller 312. Then, the CPU 205 temporarily stops the reversing roller 312 in a state in which a trailing end of the sheet material is nipped by the reversing roller 312. Subsequently, the CPU 205 causes the reversing flapper 311 to swing in a clockwise direction in FIG. 3. Also, the CPU 205 rotates the reversing roller 312 in an opposite direction. Accordingly, the CPU 205 controls the conveyance of the sheet material such that the sheet material is switched back and guided to the two-side tray 314 with a leading end and the trailing end of the sheet material switched.

The sheet material is temporarily stacked on the two-side tray 314, and then is again fed to a registration roller 316 by a re-feeding roller 315. Herein, the sheet material is fed in a state in which the side opposite the first side which has undergone the transfer process faces the photoconductor drum. Then, as similar to the aforementioned process, an image for the second side is formed on the second side of the sheet material. Accordingly, the images are formed on both sides of the sheet material. After the fixing process, the sheet material is ejected to the outside from the apparatus body of the printing apparatus 100 via the sheet ejection roller 310.

The CPU 205 controls the operations of the printing apparatus 100 such that duplex printing is executed by such a series of sequences. The control for executing the duplex printing has been described. However, the control described herein is one example and is not limited thereto.

The printing apparatus 100 also includes a sheet feed unit in which sheets for print processing are stored. The printing apparatus 100 includes, for example, sheet feed cassettes 317 and 318 (e.g., 500 sheets can be stored in each of the sheet feed cassettes), a sheet feed deck 319 (e.g., 5000 sheets can be stored), and a manual feed tray 320 each of which serves as the sheet feed unit. In the sheet feed cassettes 317 and 318 and the sheet feed deck 319, sheets of various sizes or materials can be set independently for each sheet feed unit. Moreover, in the manual feed tray 320, sheets of various types including a special sheet such as an overhead projector (OHP) sheet can be set.

### Inserter apparatus

A sheet ejected from the printing apparatus 100 as an upstream apparatus is received by a receiving roller 37 and is provided inside the inserter apparatus 200-3c. The sheet provided inside the inserter apparatus 200-3c by the receiving roller 37 is ejected to the outside of the inserter apparatus 200-3c by an ejection roller 39 via a horizontal path 38.

The inserter apparatus 200-3c includes a first tray 31 and a second tray 32 each serving as a stacking portion on which an insert sheet is stacked. In the following description, each of the first tray 31 and the second tray 32 is stated as a “slip sheet tray” if a distinction between the first and second trays 31 and 32 is not necessary. The term “insert sheet” represents a sheet to be inserted by the inserter apparatus 200-3c other than a recording sheet on which an image is formed by the printing apparatus 100 among sheets to be ejected as products by the printing system 1000 to an ejection destination Z of the saddle stitching binding machine 200-3b.

Examples of the insert sheet include paper that is inserted as a paper count mark every time a certain number of recording sheets is output, and a sheet (generally referred to as a slip sheet) that is inserted to prevent bleed-through of an image on a recording sheet. In addition, examples of the insert sheet include sheets such as a chapter title page, and a page that is printed separately so that the page is inserted between sheets on which images are formed by the printing apparatus 100. The sheets such as a chapter tile page and a separately printed page become a part of the final product with the recording sheets on which images are formed by the printing apparatus 100. Since a typical example of the insert sheet is a slip sheet, in the following description, an insert sheet to be fed from the inserter apparatus 200-3c is described as a “slip sheet” without distinction of intended use. Similar to the recording sheet, the slip sheet may be a sheet other than paper. Since a recording sheet on which an image is formed by the printing apparatus 100 generally becomes a body part of a product to be output by the printing system 1000, the recording sheet is described as “body text” and is distinguished from the slip sheet in the following description.

Slip sheets can be stacked and set on the first tray 31 and the second tray 32. Each of the first tray 31 and the second tray 32 independently moves up and down by a motor, and is movable to a first position in which a stacked slip sheet can be fed and a second position in which the tray can be replenished with slip sheets (not illustrated). If the first tray 31 is in the first position, the first tray 31 cannot be replenished with slip sheets. If the first tray 31 is in the second position, a slip sheet stacked on the first tray 31 cannot be fed. If the second tray 32 is in the first position, the second tray 32 cannot be replenished with slip sheets. If the second tray 32 is in the second position, a slip sheet stacked on the second tray 32 cannot be fed. Hereinafter, a description is given using an example in which the first tray 31 and the second tray 32 move up and down by a motor. However, another configuration may be employed. For example, each of sheet feed rollers 33 and 34 may be independently raised or lowered to move the first tray 31 and the second tray 32 to the first position and the second position.

The sheet feed roller 33 comes into contact with an upper surface of the slip sheet stacked on the first tray 31, so that the slip sheet stacked on the first tray 31 can be fed. That is, when the sheet feed roller 33 is in contact with the upper surface of the stacked slip sheet, the first tray 31 is in the first position in which the slip sheet can be fed. On the other hand, when the sheet feed roller 33 is separated from the upper surface of the slip sheet stacked on the first tray 31, the first tray 31 is in the second position in which the first tray 31 can be replenished with slip sheets. Moreover, the sheet feed roller 34 comes into contact with an upper surface of the slip sheet stacked on the second tray 32, so that the slip sheet stacked on the second tray 32 can be fed. That is, when the sheet feed roller 34 is in contact with the upper surface of the stacked slip sheet, the second tray 32 is in the first position in which the slip sheet can be fed. On the other hand, when the sheet feed roller 34 is separated from the upper surface of the slip sheet stacked on the second tray 32, the second tray 32 is in the second position in which the second tray 32 can be replenished with slip sheets. An insert sheet feeding unit of the present embodiment includes the first tray 31, the second tray 32, and the sheet feed rollers 33 and 34.

Moreover, a remaining sheet sensor 40 is disposed on the first tray 31. The remaining sheet sensor 40 detects information about a remaining quantity of slip sheets stacked on the first tray 31. Similarly, a remaining sheet sensor 41 is disposed on the second tray 32. The remaining sheet sensor 41 detects information about a remaining quantity of slip sheets stacked on the second tray 32. A remaining quantity detector of the present embodiment is each of the remaining sheet sensors 40 and 41. In the present embodiment, the remaining sheet sensor 40 detects that a remaining quantity of slip sheets on the first tray 31 is large if a remaining quantity of slip sheets stacked on the first tray 31 is greater than a predetermined set quantity, a remaining quantity of slip sheets on the first tray 31 is small if a remaining quantity of slip sheets stacked on the first tray 31 is a set quantity or less, and there is no slip sheet on the first tray 31 if no slip sheet is stacked on the first tray 31. The remaining sheet sensor 41 detects that a remaining quantity of slip sheets on the second tray 32 is large if a remaining quantity of slip sheets stacked on the second tray 32 is greater than a predetermined set quantity, a remaining quantity of slip sheets on the second tray 32 is small if a remaining quantity of slip sheets stacked on the second tray 32 is a set quantity or less, and there is no slip sheet on the second tray 32 if no slip sheet is stacked on the second tray 32. In the inserter apparatus 200-3c, the slip sheet which has been set on the first tray 31 is guided to a vertical path 35 by the sheet feed roller 33. The slip sheet which has been set on the second tray 32 is guided to the vertical path 35 by the sheet feed roller 34. The slip sheet guided to the vertical path 35 is fed to the horizontal path 38 via a conveyance roller 36, and then is ejected to the outside of the inserter apparatus 200-3c by the ejection roller 39. FIG. 3 illustrates a configuration in which the sheet ejected to the outside of the inserter apparatus 200-3c by the ejection roller 39 is provided to the inside of the charge removal apparatus 200-3a.

### Charge Removal Apparatus

Next, the charge removal apparatus 200-3a is described with reference to FIG. 3.

The charge removal apparatus 200-3a includes a charge removal roller 322 and a roller that is paired with the charge removal roller 322, and a sheet that has been conveyed to the charge removal apparatus 200-3a is conveyed while being nipped by both the rollers. Thus, the charge removal roller 322 roughly removes electric charge from the sheet. Then, an ionizer 323 removes remaining electric charge from the sheet while the sheet is being conveyed toward the outside of the charge removal apparatus 200-3a by a conveyance roller 324.

FIG. 5 is a diagram illustrating an example of the charge removal operation unit 220 of the charge removal apparatus 200-3a.

In FIG. 5, a mode setting switch 601 enables or skips (ON/OFF) the charge removal processing performed by the charge removal apparatus 200-3a. Only when the mode setting switch 601 is ON, the CPU 205 performs control to execute the charge removal processing described below.

An adjustment dial 602 formed of a thumbwheel switch adjusts a degree of charge removal control to be performed when the mode setting switch 601 is ON. The adjustment dial 602 is controlled by the CPU 205 such that the adjustment dial 602 is enabled only when the mode setting switch 601 is ON.

### Charge Removal Processing

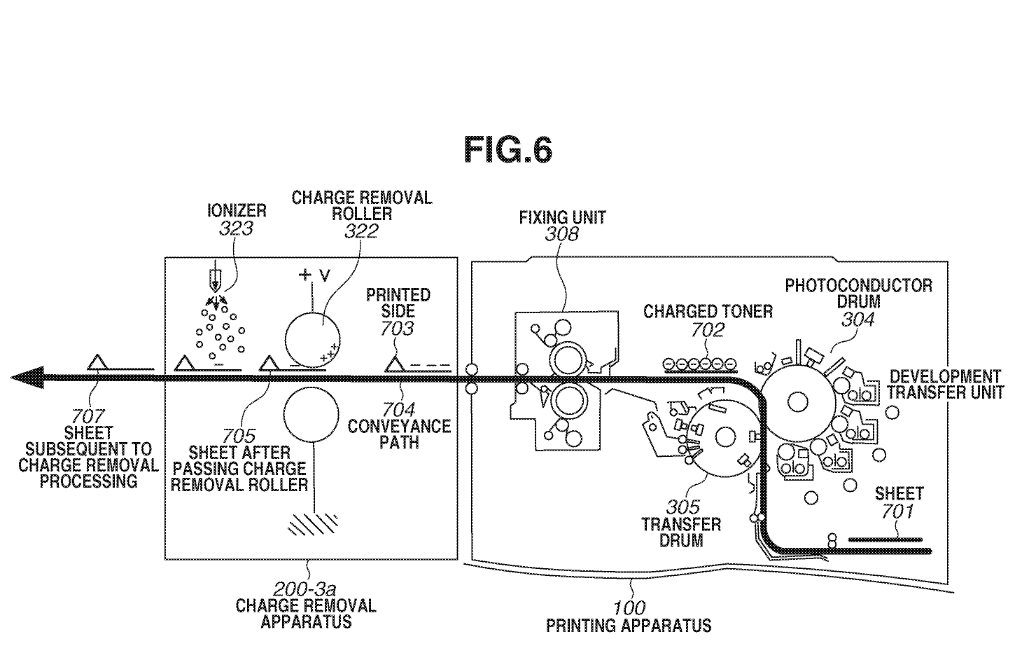

The charge removal processing to be executed by the charge removal apparatus 200-3a is described with reference to FIG. 6.

FIG. 6 is a diagram schematically illustrating a state in which the charge removal apparatus 200-3a performs the charge removal processing on a sheet that has undergone print processing in the printing apparatus 100.

First, a sheet 701 is conveyed to a development transfer unit including the photoconductor drum 304 and the transfer drum 305 via a conveyance path 704, and a charged toner 702 adheres to the sheet. The charged toner 702 on the sheet is negatively charged. Then, the sheet passes through the fixing unit 308, and the sheet subsequent to the fixing is conveyed to the charge removal apparatus 200-3a in a state in which a printed side 703 of the sheet is negatively charged. The charge removal apparatus 200-3a includes the positively-charged charge removal roller 322. The charge removal roller 322 contacts the negatively charged printed side 703 to apply a positive charge to the printed side 703 in a charge removal manner, so that the charged state of the printed side 703 is eliminated. However, it is conceivable that the negative charge not removed in the charge removal processing by the charge removal roller 322 or the applied positive charge may remain on a sheet 705 that is the sheet after passing the charge removal roller 322. Accordingly, the charge removal apparatus 200-3a in the present embodiment includes the ionizer 323 disposed downstream of the charge removal roller 322. The ionizer 323 is a device that applies voltage to an electrode needle disposed inside thereof to generate corona discharge and uses ions generated by the corona discharge to remove electric charge. Accordingly, the electric charge is roughly removed by the charge removal roller 322, and the remaining charge is corrected by the ionizer 323. Thus, a sheet 707 subsequent to the charge removal processing and ejected from the charge removal apparatus 200-3a is in a state in which the electric charge is removed.

### Saddle Stitching Binding Machine

Next, the saddle stitching binding machine 200-3b is described.

The saddle stitching binding machine 200-3b performs sheet processing. Examples of the sheet processing include saddle stitching binding, punching, cutting, shifted-sheet ejecting, folding, and stapling. Herein, these jobs are referred to as “saddle stitching binding jobs”.

In a case where a saddle stitching binding job is processed, the CPU 205 first causes a sheet corresponding to the job and printed by the printing apparatus 100 to be conveyed to the saddle stitching binding machine 200-3b. Then, the CPU 205 causes the saddle stitching binding machine 200-3b to execute sheet processing of the job. Subsequently, the CPU 205 causes printed matter corresponding to the saddle stitching binding job and having undergone the sheet processing by the saddle stitching binding machine 200-3b to be held in an ejection destination Z of the saddle stitching binding machine 200-3b. The ejection destination Z includes a plurality of ejection destination options. Since the saddle stitching binding machine 200-3b can execute a plurality of types of sheet processing, the destinations are separated for each sheet processing. In the present embodiment, detailed description of the conveyance procedure of the saddle stitching biding job is omitted.

### Connection of Each Apparatus

Here, connection of each of the apparatuses is described. The example illustrated in FIG. 3 has been described using the configuration in which the inserter apparatus 200-3c and the charge removal apparatus 200-3a are connected in order in the printing system 1000.

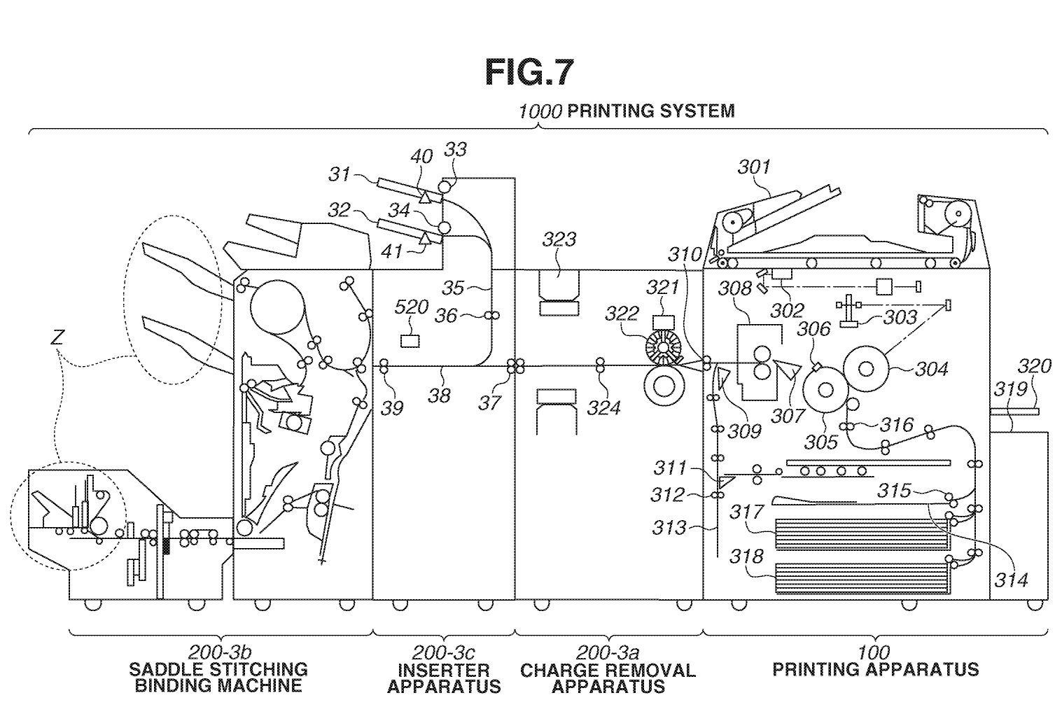

On the other hand, the charge removal apparatus 200-3a and the inserter apparatus 200-3c may be connected in this order when a printing system is placed by a user. FIG. 7 illustrates a state in which the charge removal apparatus 200-3a and the inserter apparatus 200-3c are connected in order in the printing system. The printing apparatus 100 and the apparatuses 200 connected downstream of the printing apparatus 100 communicate with the CPU 205 by a common communication I/F, so that the CPU 205 determines connection positions of the apparatuses. That is, even in a case where positions of the inserter apparatus 200-3c and the charge removal apparatus 200-3a are interchanged between upstream and downstream, the CPU 205 notifies the various sheet processing apparatuses 200 of a print instruction from the printing apparatus 100 based on the connection order of the various sheet processing apparatuses 200. After the printing apparatus 100 performs printing on a sheet, the various apparatuses 200 perform operations in which the sheet passes conveyance paths of the various apparatuses 200 and is ejected based on the print instruction from the apparatus body operation unit 204. Then, the saddle stitching binding machine 200-3b performs sheet processing, and the resultant sheet is ejected to the ejection destination Z. In the connection state illustrated in FIG. 7, electric charge cannot be removed from a slip sheet to be fed from the first tray 31 or the second tray 32 of the inserter apparatus 200-3c.

### FIRST EMBODIMENT

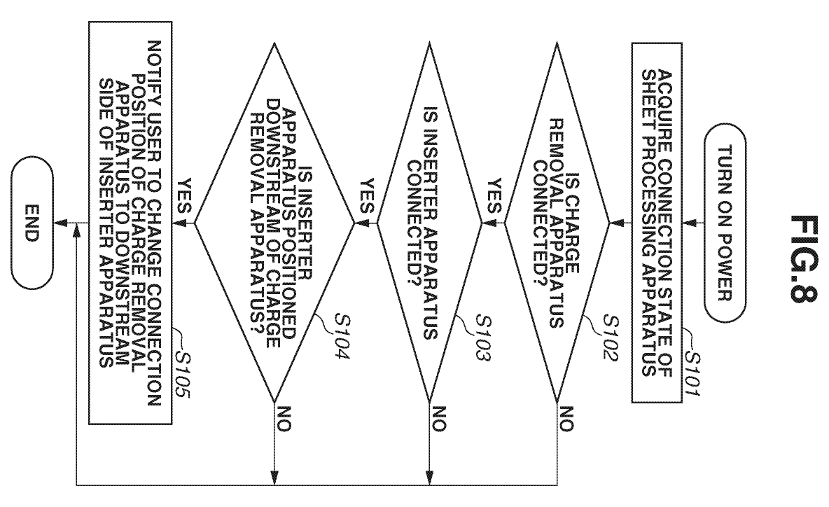

FIG. 8 is a flowchart illustrating processing according to the first embodiment. The processing of this flowchart begins after the power of the printing system 1000 is turned on. The CPU 205 loads a program stored in storages such as the ROM 207 and the HDD 209 to the RAM 208 to execute the program, so that the processing is performed.

In step S101, after the power is turned on, the printing apparatus 100 and an apparatus connected downstream of the printing apparatus 100 communicate with each other, so that the CPU 205 acquires information about a connection state of the sheet processing apparatus 200 connected to the printing apparatus 100.

In step S102, the CPU 205 determines whether the charge removal apparatus 200-3a is connected. If the CPU 205 determines that the charge removal apparatus 200-3a is connected (YES in step S102), the operation proceeds to step S103. If the CPU 205 determines that the charge removal apparatus 200-3a is not connected (NO in step S102), the processing ends.

In step S103, the CPU 205 determines whether the inserter apparatus 200-3c is connected. If the CPU 205 determines that the inserter apparatus 200-3c is not connected (NO in step S103), the processing ends.

If the CPU 205 determines that the inserter apparatus 200-3c is connected (YES in step S103), the operation proceeds to step S104.

In step S104, the CPU 205 determines whether the inserter apparatus 200-3c is positioned on a downstream side of the charge removal apparatus 200-3a in a sheet conveyance direction. If the CPU 205 determines that the inserter apparatus 200-3c is positioned on the downstream side of the charge removal apparatus 200-3a in the sheet conveyance direction (YES in step S104), the operation proceeds to step S105. On the other hand, the inserter apparatus 200-3c is not positioned on the downstream side of the charge removal apparatus 200-3a in the sheet conveyance direction (NO in step S104), the processing ends.

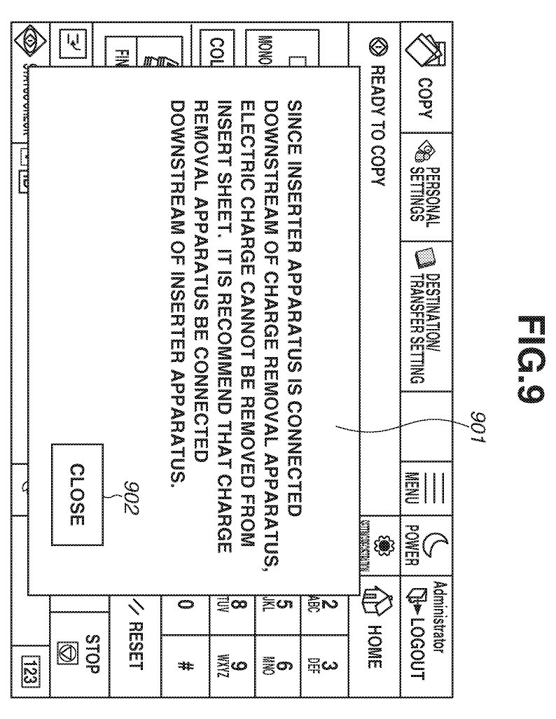

In step S105, the CPU 205 causes a screen 901 (see FIG. 9) to be displayed on the apparatus body operation unit 204. Herein, the screen 901 prompts a user to change a connection position of the charge removal apparatus 200-3a to the downstream side of the inserter apparatus 200-3c in the sheet conveyance direction. Upon checking the display, the user can turn off the printing system 1000 to change the connection. Alternatively, the user can press a “close” button 902 on the screen 901 illustrated in FIG. 9 to use the printing system 1000 in the connection state as is. If the inserter apparatus 200-3c is positioned on an upstream side of the charge removal apparatus 200-3a (NO in step S104), the processing ends.

According to the present embodiment, the user can be warned in advance in a case where the charge removal processing cannot be performed appropriately on a sheet to be inserted from the inserter apparatus 200-3c.

### SECOND EMBODIMENT

In the first embodiment, a description has been given of the method for notifying a user to connect the charge removal apparatus 200-3a to the downstream side of the inserter apparatus 200-3c when the power of the printing system 1000 is turned on. In the first embodiment, however, the user may not notice the display. In the second embodiment, the user is notified even in a case where it is determined that a job involves feeding of a sheet from a first tray 31 or a second tray 32 of an inserter apparatus 200-3c when printing is started.

### Print Processing

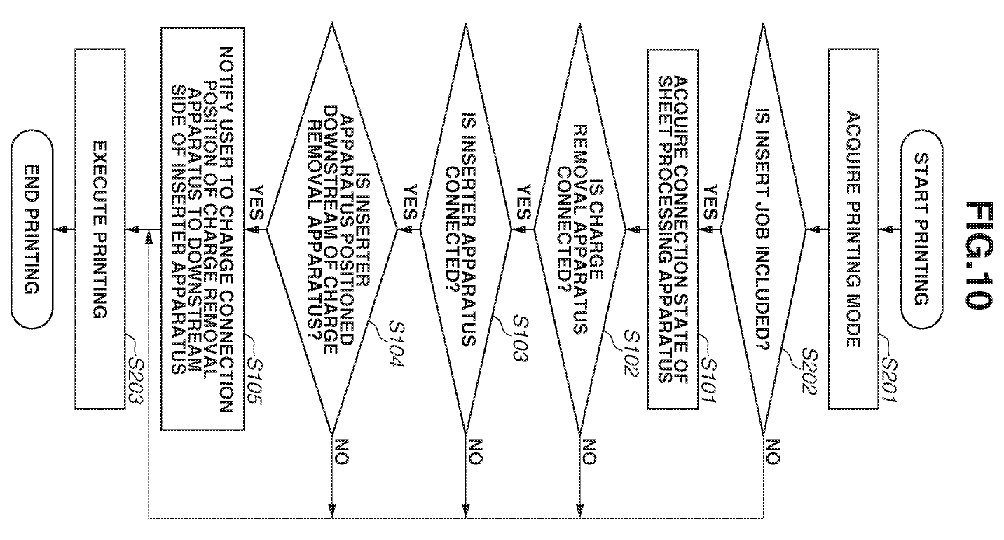

FIG. 10 is a flowchart illustrating print processing according to the second embodiment. A CPU 205 of a printing apparatus 100 loads a program stored in storages such as a ROM 207 and an HDD 209 to a RAM 208 to execute the program, so that the processing of the flowchart is executed. The processing is executed when a print job is input to a printing system 1000. In FIG. 10, the step same as that of FIG. 8 is given the same step number as above. Hereinafter, only a step different from that of FIG. 8 is described, while a description of the same step as that of FIG. 8 is omitted.

In step S201, the CPU 205 acquires a printing mode that has been input.

In step S202, the CPU 205 determines whether a sheet to be fed from the first tray 31 or the second tray 32 of the inserter apparatus 200-3c is included based on the acquired printing mode. If the CPU 205 determines that the sheet to be fed from the first tray 31 or the second tray 32 is included (YES in step S202), the operation proceeds up to step S105 through steps S101 to S104.

In step S105, the CPU 205 notifies a user to change a connection position of the charge removal apparatus 200-3a to a downstream side of the inserter apparatus 200-3c in a sheet conveyance direction. Since sheet feeding has not been started at this time, the user can turn off the power of the printing system 1000 here to change the connection position, or can press a “close” button 902 on a screen 901 illustrated in FIG. 9 to execute the printing in step S203.

After the printing, the CPU 205 finishes the processing.

According to the embodiment, therefore, a connection error in which the inserter apparatus 200-3c is connected to a downstream side of the charge removal apparatus 200-3a in a sheet conveyance direction at the time of placement is prevented. As a result, electric charge can be appropriately removed from a fed sheet.

In a case where the inserter apparatus 200-3c is dedicated to insertion of uncharged slip sheets, a setting may be made such that the notification function can be disabled since the operation becomes complicated if unnecessary warning is issued every time a job is performed.

The above embodiment has been described using the example in which the inserter apparatus and the charge removal apparatus serve as the sheet processing apparatuses. However, the above embodiment may be applied to a saddle stitching binding machine. In a such case, if the saddle stitching binding machine is disposed on a downstream side of the charge removal apparatus in a sheet conveyance direction, a notification can prompt a user to change a connection order.

It is conceivable that examples of the sheet processing apparatus can include various apparatuses. For example, an enclosing and sealing device for inserting printed matter into an envelope may be incorporated into a printing system, and the connection-related notification of the present disclosure may function in such a printing system.

### Other Embodiments

The configuration of various data and the contents thereof described above are not limited thereto, and may be variously provided according to a purpose and a use.

Although the present disclosure has described example embodiments, the present disclosure can be embodied as, for example, a system, an apparatus, a method, a program, or a storage medium. Particularly, the present disclosure can be applied to a system including a plurality of pieces of equipment, or an apparatus including single equipment.

In addition, the present disclosure includes all the configurations obtained by combining the above embodiments.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-059520, which was filed on Mar. 31, 2025 and which is hereby incorporated by reference herein in its entirety.

What is claimed is:

1. A printing system comprising:
a printing apparatus configured to perform printing on a sheet;
an inserter apparatus placed on a downstream side of the printing apparatus in a sheet conveyance direction and configured to insert the sheet;
a charge removal apparatus placed on a downstream side of the printing apparatus in the sheet conveyance direction and configured to remove electric charge from the sheet; and
at least one processor configured to generate a notification that notifies a user to connect the inserter apparatus to a downstream side of the charge removal apparatus in the sheet conveyance direction in a case where it is determined that the inserter apparatus is connected to an upstream side of the charge removal apparatus in the sheet conveyance direction.

2. The printing system according to claim 1, wherein, in a case where power is turned on, the at least one processor generates a notification that notifies a user to change a connection position of the inserter apparatus.

3. The printing system according to claim 1, wherein, in a case where a received print job is executed, the at least one processor generates a notification that notifies a user to change a connection position.

4. The printing system according to claim 3, wherein, in a case where the user checks the notification that notifies the user to change the connection position, printing is executed.

5. The printing system according to claim 1, wherein generation of the notification is stopped by a setting.

6. A control method for a printing system including a printing apparatus configured to perform printing on a sheet, an inserter apparatus placed on a downstream side of the printing apparatus in a sheet conveyance direction and configured to insert the sheet, and a charge removal apparatus placed on a downstream side of the printing apparatus in the sheet conveyance direction and configured to remove electric charge from the sheet, the control method comprising:
determining whether the inserter apparatus is connected to a downstream side of the charge removal apparatus in the sheet conveyance direction; and
notifying a user to connect the inserter apparatus to the downstream side of the charge removal apparatus in the sheet conveyance direction in a case where it is determined that the inserter apparatus is connected to an upstream side of the charge removal apparatus in the sheet conveyance direction.

7. A non-transitory computer-readable storage medium storing computer-executable instructions for causing a computer to execute a control method for a printing system including a printing apparatus configured to perform printing on a sheet, an inserter apparatus placed on a downstream side of the printing apparatus in a sheet conveyance direction and configured to insert the sheet, and a charge removal apparatus placed on a downstream side of the printing apparatus in the sheet conveyance direction and configured to remove electric charge from the sheet, the control method comprising:
determining whether the inserter apparatus is connected to a downstream side of the charge removal apparatus in the sheet conveyance direction; and
notifying a user to connect the inserter apparatus to the downstream side of the charge removal apparatus in the sheet conveyance direction in a case where it is determined that the inserter apparatus is connected to an upstream side of the charge removal apparatus in the sheet conveyance direction.
